(19) United States
(12) Patent Application Publication
(10) Pub. No.: US 2020/0133654 A1
(43) Pub. Date: Apr. 30, 2020

(54) METHOD FOR REMOTELY UPDATING FIRMWARE OF FIELD PROGRAMMABLE GATE ARRAY

(71) Applicant: Mitac Computing Technology Corporation, Taoyuan City (TW)

(72) Inventors: Yun-Shan LEI, Taoyuan City (TW); Lung-Chiao CHANG, Taoyuan City (TW); Cheng-Yu CHUANG, Taoyuan City (TW); Peng XIE, Taoyuan City (TW)

(73) Assignee: Mitac Computing Technology Corporation, Taoyuan City (TW)

(21) Appl. No.: 16/560,362

(22) Filed: Sep. 4, 2019

(30) Foreign Application Priority Data
Oct. 25, 2018 (TW) 107137729

(51) Int. Cl. G06F 8/65; H04L 29/08

(52) U.S. Cl. CPC G06F 8/65; H04L 67/34

(57) ABSTRACT

A method for remotely updating firmware of a field programmable gate array (FPGA) includes: by a controller, transmitting a storing instruction and relaying an entry of configuration data received from a remote device to a processor of the FPGA; by the processor, performing an updating subtask to store a file segment recorded in the entry of configuration data in an update-storage area indicated by location information recorded in the entry of configuration data; by the controller, determining whether the processor has successfully completed the updating subtask, and when affirmative, enabling the remote device to transmit another entry of configuration data; and repeating the aforementioned steps.

### CROSS-REFERENCE TO RELATED APPLICATION

This application claims priority of Taiwanese Invention Patent Application No. 107137729, filed on Oct. 25, 2018.

### FIELD

The disclosure relates to a method for updating firmware, and more particularly to a method for remotely updating firmware of a field programmable gate array.

### BACKGROUND

In view of their high performance, high reliability and low power consumption, field programmable gate arrays (FPGA) are often utilized in server management (e.g., power sequence of starting up of a server after power-on or inter-module communications). Since the FPGA is responsible for normal operation of a server, regularly updating firmware of the FPGA is essential for enhancing information security. Conventionally, the firmware of the FPGA is manually updated by an on-site technician through interconnecting a tool board loaded with a patch to a connector of a printed circuit board (PCB) where the FPGA is mounted after disassembling the server. However, disassembling servers one by one for interconnecting the tool board and connectors to update the firmware of FPGAs in the servers is time-consuming and inefficient.

### SUMMARY

Therefore, an object of the disclosure is to provide a method for remotely updating firmware of a field programmable gate array (FPGA) that can alleviate at least one of the drawbacks of the prior art.

According to the disclosure, the FPGA is electrically connected to a controller, and includes a storage and a processor. The storage has a plurality of update-storage areas. The processor is electrically connected to the storage and the controller. The controller is communicable with a remote device via a communication network. The remote device is used to sequentially transmit plural entries of configuration data to the controller. The method is to be implemented by the controller and the processor of the FPGA. The method includes steps of:

(A) transmitting, by the controller after receiving one of the entries of configuration data transmitted by the remote device, a storing instruction and said one of the entries of configuration data to the processor, the entries of configuration data corresponding to an update file, each of the entries of configuration data recording a respective one of file segments into which the update file is divided, and location information which indicates a location of a respective one of the update-storage areas;

(B) by the processor based on the storing instruction and said one of the entries of configuration data, performing an updating subtask to store the file segment recorded in said one of the entries of configuration data in one of the update-storage areas indicated by the location information recorded in said one of the entries of configuration data;

(C) determining, by the controller, whether the processor has successfully completed the updating subtask;

(D) by the controller when it is determined that the processor has successfully completed the updating subtask, generating a partial-update-success message, and transmitting the partial-update-success message to the remote device so as to enable the remote device to determine whether all of the entries of configuration data corresponding to the update file have been transmitted to the controller and to transmit, when it is determined that not all of the entries of configuration data corresponding to the update file have been transmitted to the controller, another one of the entries of configuration data to the controller.

### BRIEF DESCRIPTION OF THE DRAWINGS

Other features and advantages of the disclosure will become apparent in the following detailed description of the embodiment with reference to the accompanying drawings, of which:

FIG. 1 is a block diagram illustrating an embodiment of a system which is used to implement a method for remotely updating firmware of a field programmable gate array (FPGA) according to the disclosure; and

FIGS. 2 and 3 cooperatively constitute a flow chart for illustrating an embodiment of the method according to the disclosure.

### DETAILED DESCRIPTION

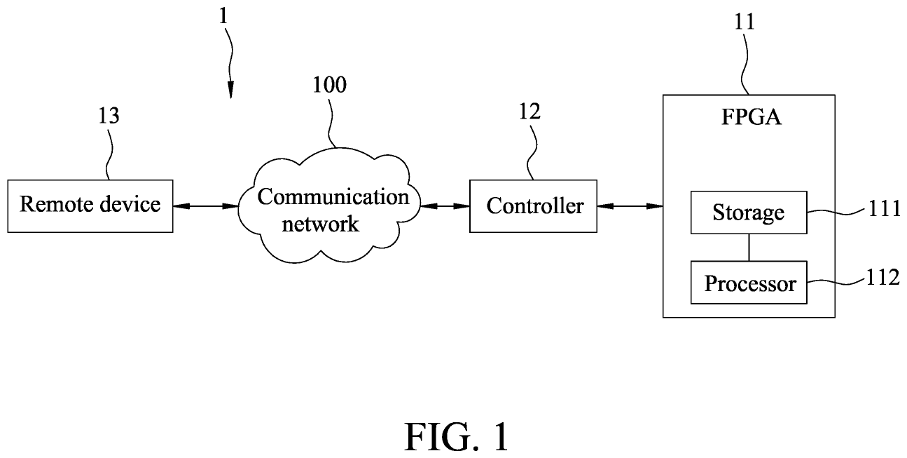

Referring to FIG. 1, an embodiment of a system 1, which is used to implement a method for remotely updating firmware of a field programmable gate array (FPGA) according to the disclosure, is illustrated. The system 1 includes an FPGA 11, a controller 12 and a remote device 13.

The FPGA 11 is electrically connected to the controller 12. The FPGA 11 includes a storage 111 and a processor 112. The processor 112 is electrically connected to the storage 111 and the controller 12. The storage 111 has a plurality of update-storage areas. The storage 111 stores firmware and a plurality of flags each of which corresponds to a respective one of the update-storage areas. Each of the flags has one of a first predetermined flag value and a second predetermined flag value. A flag having the first predetermined flag value indicates that the respective one of the update-storage areas is allowed to be written, and a flag having the second predetermined flag value indicates that the respective one of the update-storage areas is disallowed to be written. Each of the flags has the second predetermined flag value by default. In this embodiment, the storage 111 is implemented to include a non-volatile memory (NVM, not shown) and a volatile memory (not shown) such as a dynamic random access memory (DRAM) or a static random access memory (SRAM). The NVM may be an on-board flash memory of the FPGA 11 and stores the firmware and the flags. In other embodiments, the NVM may be an external memory, such as an electrically erasable programmable read only memory (EEPROM), an erasable programmable read only memory (EPROM), a flash memory, or the like, connected to the FPGA 11. It should be noted that implementation of the storage 111 may vary in other embodiments and is not limited to the disclosure herein.

The controller 12 is communicable with the remote device 13 via a communication network 100. The controller 12 stores an entry of reference account data, a count value and a threshold value. The entry of reference account data includes an IP address related to the controller 12, a username and a password. The communication network 100 is exemplified to be a local area network (LAN) in a business organization. The controller 12 is exemplified to be a baseboard management controller (BMC), a microcontroller unit (MCU) or another FPGA, etc. However, implementations of the controller 12, the communication network 100 and the reference account data are not limited to the disclosure herein and may vary in other embodiments.

The remote device 13 stores plural entries of configuration data, and is used to sequentia lly transmit the entries of configuration data to the controller 12. The entries of configuration data in combination correspond to an update file. Each of the entries of configuration data records a respective one of file segments into which the update file is divided, and location information which indicates a location of a respective one of the update-storage areas in the storage 111. In this embodiment, the remote device 13 is a desktop computer, and each of the file segments of the entries of configuration data is 4 bytes in file size, but implementations of the remote device 13 and the file segments are not limited to the disclosure herein and may vary in other embodiments.

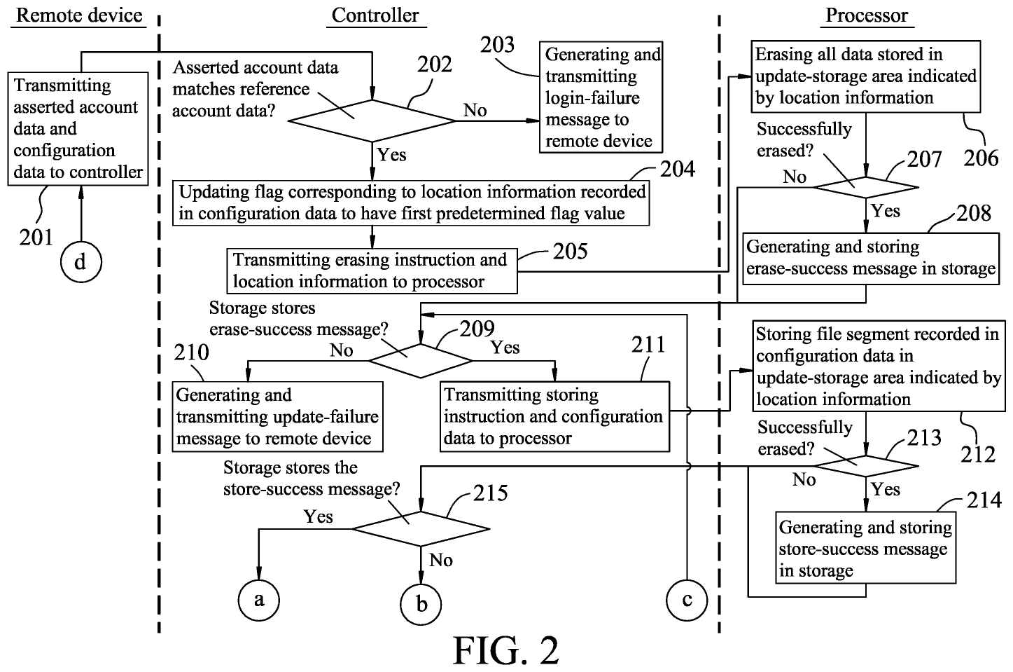

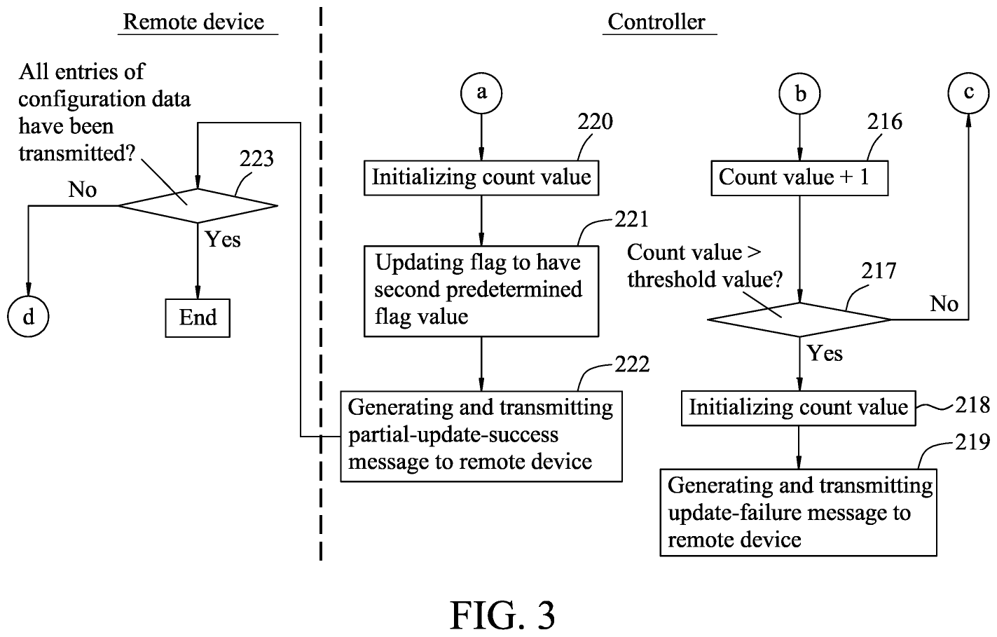

Referring to FIGS. 1 to 3, an embodiment of the method for remotely updating firmware of an FPGA according to the disclosure is illustrated. The method is to be implemented by the controller 12 and the processor 112 of the FPGA 11, and includes steps 201 to 223 described as follows.

In step 201, the remote device 13 transmits an entry of asserted account data and one of the entries of configuration data to the controller 12.

In step 202, after receiving the entry of asserted account data and said one of the entries of configuration data transmitted by the remote device 13, the controller 12 determines whether the entry of asserted account data matches the entry of reference account data. When it is determined by the controller 12 that the entry of asserted account data does not match the entry of reference account data, a flow of procedure proceeds to step 203. When it is determined by the controller 12 that the entry of asserted account data matches the entry of reference account data, the flow proceeds to step 204.

In step 203, the controller 12 generates a login-failure message, and transmits the same to the remote device 13.

In step 204, based on the location information recorded in said one of the entries of configuration data, the controller 12 updates one of the flags that corresponds to one of the update-storage areas indicated by the location information to have the first predetermined flag value.

In step 205, the controller 12 transmits an erasing instruction and the location information recorded in said one of the entries of configuration data to the processor 112.

In step 206, based on the erasing instruction and the location information, the processor 112 performs an erasing subtask to erase all data stored in the one of the update-storage areas indicated by the location information.

In step 207, the processor 112 determines whether the processor 112 has successfully completed the erasing subtask (i.e., whether all of the data stored in the one of the update-storage areas indicated by the location information has been erased). When it is determined that the processor 112 has successfully completed the erasing subtask, the flow proceeds to step 208. Otherwise, the flow proceeds to step 209.

In step 208, the processor 112 generates an erase-success message, and stores the erase-success message in the storage 111. Thereafter, the flow proceeds to step 209.

In step 209, the controller 12 determines whether the storage 111 stores the erase-success message so as to determine whether the processor 112 has successfully completed the erasing subtask. When it is determined by the controller 12 that the storage 111 does not store the erase-success message, the flow proceeds to step 210. When it is determined by the controller 12 that the storage 111 stores the erase-success message, the flow proceeds to step 211.

In step 210, the controller 12 generates an update-failure message, and transmits the update-failure message to the remote device 13.

In step 211, the controller 12 transmits a storing instruction and said one of the entries of configuration data to the processor 112.

In step 212, based on the storing instruction and said one of the entries of configuration data, the processor 112 performs an updating subtask to store the file segment recorded in said one of the entries of configuration data in the one of the update-storage areas indicated by the location information recorded in said one of the entries of configuration data.

In step 213, the processor 112 determines whether the file segment recorded in said one of the entries of configuration data has been successfully stored in the one of the update-storage areas indicated by the location information. When it is determined by the processor 112 that the file segment recorded in said one of the entries of configuration data has been successfully stored in the one of the update-storage areas indicated by the location information, the flow proceeds to step 214. Otherwise, the flow proceeds to step 215.

In step 214, the processor 112 generates a store-success message and stores the store-success message in the storage 111. It should be noted that in this embodiment, after the processor 112 has stored the store-success message in the storage 111, the controller 12 reads a last file segment which is one of the file segments last stored in one of the update-storage areas of the storage 111, and transmits the last file segment read by the controller 12 to the remote device 13 so as to enable the remote device 13 to compare the last file segment received by the remote device 13 from the controller 12 with the file segment recorded in one of the entries of configuration data which is transmitted last by the remote device 13 to the controller 12, and to determine whether the aforementioned two file segments match with each other. In this way, the remote device 13 is able to determine whether the file segment recorded in said one of the entries of configuration data has been correctly stored in the one of the update-storage areas of the storage 111 indicated by the location information.

In step 215, the controller 12 determines whether the storage 111 stores the store-success message so as to determine whether the processor 112 has successfully completed the updating subtask (i.e., whether the file segment recorded in said one of the entries of configuration data is stored in the one of the update-storage areas indicated by the location information). When it is determined by the controller 12 that the processor 112 has not successfully completed the updating subtask (i.e., the storage 111 does not store the store-success message), the flow proceeds to step 216. Oppositely, when it is determined by the controller 12 that the processor 112 has successfully completed the updating subtask (i.e., the storage 111 stores the store-success message), the flow proceeds to step 220.

In step 216, the controller 12 adds one to the count value. Then, the flow proceeds to step 217.

In step 217, the controller 12 determines whether the count value is greater than the threshold value. When it is determined by the controller 12 that the count value is greater than the threshold value, the flow proceeds to step 218. When it is determined by the controller 12 that the count value is not greater than the threshold value, the flow proceeds to step 209.

In step 218, the controller 12 initializes the count value (e.g., reset the count value to 0 or 1, as the case may be). After that, the flow proceeds to step 219.

In step 219, the controller 12 generates an update-failure message, and transmits the same to the remote device 13.

In step 220, the controller 12 initializes the count value, and then the flow proceeds to step 221.

In step 221, the controller 12 updates said one of the flags corresponding to the one of the update-storage areas indicated by the location information recorded in said one of the entries of configuration data to have the second predetermined flag value. Thereafter, the flow proceeds to step 222.

In step 222, the controller 12 generates a partial-update-success message, and transmits the partial-update-success message to the remote device 13. Then, the flow proceeds to step 223.

In step 223, the remote device 13 determines whether all of the entries of configuration data corresponding to the update file have been transmitted to the controller 12. When it is determined by the remote device 13 that not all of the entries of configuration data corresponding to the update file have been transmitted to the controller 12, the flow goes back to step 201 where the remote device 13 transmits another one of the entries of configuration data to the controller 12. Otherwise, the flow goes to an end.

It is worth to note that in this embodiment, the remote device 13 determines whether all of the entries of configuration data corresponding to the update file have been transmitted to the controller 12 based on whether or not a final marker exists in one of the entries of configuration data which is last transmitted to the controller 12. The final marker indicates that the entry of configuration data where the final marker exists is the final one of a sequence of the entries of configuration data corresponding to the update file to be transmitted to the controller 12. Note that in this case, the entries of configuration data are transmitted by the controller 12 according to the sequence, but the order in which the entries of configuration data are transmitted is not limited to the disclosure herein.

It should be noted that in other embodiments, after the remote device 13 determines that all of the entries of configuration data corresponding to the update file have been transmitted to the controller 12, the remote device 13 transmits a switching instruction via the controller 12 to the processor 112. Based on the switching instruction, the processor 112 changes a location indicator which indicates an execution location in the storage 111 for performing initialization of the firmware from a default location to a location the update file (i.e., all of the file segments) is stored. In a scenario where storage space of the FPGA 11 is limited, the update file is to be stored in the default location to overwrite an existing update file, and the location indicator is designated to indicate the default location in this scenario. Subsequently, the remote device 13 transmits a restarting instruction to the controller 12 so as to enable the controller 12 to control the processor 112 to execute a restart process of the FPGA 11. During execution of the restart process of the FPGA 11, the processor 112 refers to the execution location indicated by the location indicator, i.e., the location in the storage 111 where the update file is stored, so as to perform initialization of the firmware.

Moreover, there are two kinds of implementations for the remote device 13 to determine whether the firmware of the FPGA 11 has been correctly updated.

For one kind of the implementations, the remote device 13 transmits a version request that is related to a current version of the firmware being executed by the FPGA 11 to the controller 12 after a predetermined time interval has elapsed since the remote device 13 transmits the restarting instruction to the controller 12. In response to receipt of the version request, the controller 12 obtains, via the FGPA 11, a version identifier that is specific to a version of the firmware and that is recorded in the update file which is stored in the execution location in the storage 111 of the FPGA 11, and transmits the version identifier to the remote device 13. The remote device 13 determines whether the firmware of the FPGA 11 has been correctly updated based on a comparison between the version identifier thus requested and another version identifier that is recorded in the update file which was transmitted by the remote device 13 to the controller 12.

For another kind of the implementations, after the FPGA 11 has executed the update file, the controller 12 obtains the version identifier that is specific to the current version of the firmware being executed by the FGPA 11 and that is recorded in the update file which is stored in the execution location in the storage 111 of the FPGA 11, and stores the version identifier. Later on, when the remote device 13 transmits the version request to the controller 12, the controller 12 will return the version identifier to the remote device 13 so as to enable the remote device 13 to determine whether the firmware of the FPGA 11 has been correctly updated based on the version identifier.

In one embodiment, in response to receipt of an update instruction that contains a version identifier and an IP address/MAC address which is related to a controller, the remote device 13 determines one of the controllers that corresponds to the IP address/MAC address contained in the update instruction, determines an update file to be transmitted based on the version identifier contained in the update instruction, and transmits the update file thus determined to said one of the controllers 12 thus determined.

In one embodiment, the remote device 13 stores a predetermined management table which records correspondence relationships of controllers 12 and version identifiers. Each of the version identifiers corresponds to a latest version of an update file to be installed on the corresponding one of the controllers 12. In response to receipt of an update instruction that contains an IP address/MAC address which is related to one of the controllers 12, the remote device 13 determines which of the controllers 12 is said one of the controllers 12 based on the IP address/MAC address contained in the update instruction, looks up the version identifier corresponding to the controller 12 thus determined in the management table, determines an update file to be transmitted based on the version identifier thus looked up, and transmits the update file thus determined to said one of the controllers 12.

In one embodiment, the remote device 13 stores a predetermined management table which records correspondence relationships of controllers 12 and version identifiers. Each of the version identifiers corresponds to a latest version of an update file to be installed on the corresponding one of the controllers 12. The remote device 13 periodically checks the management table to determine whether any one of the version identifiers recorded in the management table has been updated. When it is determined that one of the version identifiers recorded in the management table has been updated, the remote device 13 automatically determines a corresponding update file to be transmitted according to said one of the version identifiers, and automatically transmits the update file thus determined to the controller 12 that corresponds to said one of the version identifiers.

In summary, the method according to the disclosure utilizes the controller 12 to sequentially receive plural entries of configuration data from the remote device 13, and to sequentially transmit the entries of configuration data, with each entry of configuration data being transmitted in combination with a corresponding storing instruction, to the FPGA 11 so as to enable the processor 112 of the FPGA 11 to store the file segments of the update file recorded in the respective entries of configuration data based on the storing instructions and the entries of configuration data. In this way, no on-site technician is required to disassemble a server for updating the firmware of the FPGA therein. Moreover, by virtue of dividing an updating task into several updating subtasks, the controller 12 requires no additional storage medium to temporarily store the whole update file received from the remote device 13 for updating the firmware of the FPGA 11 at one time. Consequently, time and manpower are both saved.

In the description above, for the purposes of explanation, numerous specific details have been set forth in order to provide a thorough understanding of the embodiment. It will be apparent, however, to one skilled in the art, that one or more other embodiments maybe practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects, and that one or more features or specific details from one embodiment may be practiced together with one or more features or specific details from another embodiment, where appropriate, in the practice of the disclosure.

While the disclosure has been described in connection with what is considered the exemplary embodiment, it is understood that this disclosure is not limited to the disclosed embodiment but is intended to cover various arrangements included within the spirit and scope of the broadest interpretation so as to encompass all such modifications and equivalent arrangements.

What is claimed is:

1. A method for remotely updating firmware of a field programmable gate array (FPGA), the FPGA electrically connected to a controller, and including a storage and a processor, the storage having a plurality of update-storage areas, the processor electrically connected to the storage and the controller, the controller communicable with a remote device via a communication network, the remote device being used to sequentially transmit plural entries of configuration data to the controller, the method comprising steps of:
(A) transmitting, by the controller after receiving one of the entries of configuration data transmitted by the remote device, a storing instruction and said one of the entries of configuration data to the processor, the entries of configuration data corresponding to an update file, each of the entries of configuration data recording a respective one of file segments into which the update file is divided, and location information which indicates a location of a respective one of the update-storage areas;
(B) by the processor based on the storing instruction and said one of the entries of configuration data, performing an updating subtask to store the file segment recorded in said one of the entries of configuration data in one of the update-storage areas indicated by the location information recorded in said one of the entries of configuration data;
(C) determining, by the controller, whether the processor has successfully completed the updating subtask;
(D) by the controller when it is determined that the processor has successfully completed the updating subtask, generating a partial-update-success message, and transmitting the partial-update-success message to the remote device so as to enable the remote device to determine whether all of the entries of configuration data corresponding to the update file have been transmitted to the controller and to transmit, when it is determined that not all of the entries of configuration data corresponding to the update file have been transmitted to the controller, another one of the entries of configuration data to the controller.

2. The method as claimed in claim 1, prior to step (A), further comprising:
(E) transmitting, by the controller after receiving said one of the entries of configuration data transmitted by the remote device, an erasing instruction and the location information recorded in said one of the entries of configuration data to the processor; and
(F) by the processor based on the erasing instruction and the location information, performing an erasing subtask to erase all of data stored in the one of the update-storage areas indicated by the location information.

3. The method as claimed in claim 2, subsequent to step (F), further comprising:
(G) determining, by the processor, whether the processor has successfully completed the erasing subtask;
(H) by the processor when it is determined that the processor has successfully completed the erasing subtask, generating an erase-success message, and storing the erase-success message in the storage;
(I) determining, by the controller, whether the storage stores the erase-success message so as to determine whether the processor has completed the erasing subtask; and
(J) by the controller when it is determined that the storage does not store the erase-success message, generating an update-failure message, and transmitting the update-failure message to the remote device, wherein when it is determined by the controller in step (I) that the storage stores the erase-success message, step (A) is to be performed.

4. The method as claimed in claim 2, the storage storing a plurality of flags each of which corresponds to a respective one of the update-storage areas, and each of which has one of a first predetermined flag value indicating that the respective one of the update-storage areas is allowed to be written andasecondpredetermined flag value indicating that the respective one of the update-storage areas is disallowed to be written, each of the flags having the second predetermined flag value by default, the method, prior to step (E), further comprising:
(K) updating, by the controller based on the location information recorded in said one of the entries of configuration data, one of the flags corresponding to the one of the update-storage areas indicated by the location information to have the first predetermined flag value. 15

5. The method as claimed in claim 4, wherein step (D) includes updating, by the controller when it is determined that the processor has successfully completed the updating subtask, said one of the flags corresponding to the one of the update-storage areas indicated by the location information recorded in said one of the entries of configuration data to have the second predetermined flag value.

6. The method as claimed in claim 1, the controller storing an entry of reference account data, the method, prior to step (A), further comprising:
(L) determining, by the controller after receiving an entry of asserted account data from the remote device, whether the entry of asserted account data matches the entry of reference account data; and
(M) proceeding to step (A) when it is determined that the entry of asserted account data matches the entry of reference account data.

7. The method as claimed in claim 1, the controller storing a count value and a threshold value, the method, subsequent to step (C), further comprising:
(N) by the controller when it is determined that the processor has not successfully completed the updating subtask, adding one to the count value, and determining whether the count value is greater than the threshold value; and
(O) proceeding to step (A) when it is determined that the count value is not greater than the threshold value, wherein step (D) includes initializing the count value by the controller.

8. The method as claimed in claim 7, subsequent to step (N), further comprising:
(P) by the controller when it is determined that the count value is greater than the threshold value, initializing the count value and transmitting an update-failure message to the remote device.

9. The method as claimed in claim 1, subsequent to step (B) and prior to step (C), further comprising:
(Q) determining, by the processor, whether the file segment recorded in said one of the entries of configuration data has been successfully stored in the one of the update-storage areas indicated by the location information; and
(R) by the processor when it is determined that the file segment recorded in said one of the entries of configuration data has been successfully stored in the corresponding one of the update-storage areas, generating a store-success message and storing the store-success message in the storage,
wherein step (C) includes determining, by the controller, whether the storage stores the store-success message so as to determine whether the processor has successfully completed the updating subtask. 20

10. The method as claimed in claim 1, further comprising:
(S) transmitting, by the remote device, a version request that is related to a current version of the firmware being executed by the FPGA to the controller after a predetermined time interval has elapsed since the remote device transmits a restarting instruction to the controller;
(T) obtaining, by the controller via the FGPA in response to receipt of the version request, a version identifier that is specific to a version of the firmware and that is recorded in the update file which is stored in an execution location in the storage of the FPGA;
(U) transmitting, by the controller, the version identifier to the remote device; and
(V) determining, by the remote device, whether the firmware of the FPGA has been correctly updated based on a comparison between the version identifier thus requested and another version identifier that is recorded in the update file which was transmitted by the remote device to the controller.

11. The method as claimed in claim 1, further comprising:
(W) by the controller after the FPGA 11 has executed the update file, obtaining a version identifier that is specific to a current version of the firmware being executed by the FGPA and that is recorded in the update file which is stored in an execution location in the storage of the FPGA, and storing the version identifier; and
(X) by the controller when the remote device transmits a version request that is related to the current version of the firmware being executed by the FPGA to the controller, transmitting the version identifier to the remote device so as to enable the remote device to determine whether the firmware of the FPGA has been correctly updated based on the version identifier.

12. A system for remotely updating firmware of a field programmable gate array (FPGA), the FPGA including a storage and a processor, the storage having a plurality of update-storage areas, the processor electrically connected to the storage, said system comprising:
a controller electrically connected to the processor of the FPGA; and
a remote device communicable with said controller via a communication network, and configured to sequentially transmit plural entries of configuration data to said controller,
wherein said controller is configured to transmit, after receiving one of the entries of configuration data transmitted by said remote device, a storing instruction and said one of the entries of configuration data to the processor, where the entries of configuration data corresponds to an update file, and each of the entries of configuration data records a respective one of file segments into which the update file is divided, and location information which indicates a location of a respective one of the update-storage areas;
wherein, based on the storing instruction and said one of the entries of configuration data, the processor performs an updating subtask to store the file segment recorded in said one of the entries of configuration data in one of the update-storage areas indicated by the location information recorded in said one of the entries of configuration data; and
wherein said controller is further configured to
determine whether the processor has successfully completed the updating subtask,
when it is determined that the processor has successfully completed the updating subtask, generate a partial-update-success message, and transmit the partial-update-success message to said remote device so as to enable said remote device to determine whether all of the entries of configuration data corresponding to the update file have been transmitted to said controller, and
transmit, when it is determined that not all of the entries of configuration data corresponding to the update file have been transmitted to said controller, another one of the entries of configuration data to said controller.
